(19) United States
(12) Patent Application Publication
(10) Pub. No.: US 2026/0118239 A1
(43) Pub. Date: Apr. 30, 2026

(54) TESTING APPARATUSES AND METHODS

(71) Applicant: Purdue Research Foundation, West Lafayette, IN (US)

(72) Inventors: Pablo D. Zavattieri, West Lafayette, IN (US); Phani Saketh Dasika, Lafayette, IN (US)

(21) Appl. No.: 19/367,091

(22) Filed: Oct. 23, 2025

Related U.S. Application Data
(60) Provisional application No. 63/711,643, filed on Oct. 24, 2024.

(51) Int. Cl. G01N 3/34; G01N 3/20

(52) U.S. Cl. CPC G01N 3/34; G01N 3/20; G01N 2203/0005; G01N 2203/0023; G01N 2203/0264; G01N 2203/0288

(57) ABSTRACT

Testing apparatuses and methods, such as for testing flexural characteristics of beams. Such a testing apparatus has opposing first and second specimen holders that are spaced apart and define a gap therebetween for a test specimen. The specimen holders include elongate slots and loading fixtures are disposed in the slots so that the loading fixtures maintain contact with the slots when urging the specimen holders in either of two opposite directions. The testing apparatus can thereby capture flexural information during both loading and unloading without having to reposition the test specimen or other components of the testing apparatus because the loading fixtures stay engaged with the specimen holders within the slots in both directions.

### CROSS-REFERENCE TO RELATED APPLICATIONS

This application claims the benefit of provisional U.S. Patent Application No. 63/711,643 filed Oct. 24, 2024, the contents of which are incorporated herein by reference.

### STATEMENT REGARDING FEDERALLY SPONSORED RESEARCH OR DEVELOPMENT

This invention was made with government support under FA9550-23-1-0209 and FA9550-15-1-0009 awarded by the Air Force Office of Scientific Research. The government has certain rights in the invention.

### BACKGROUND OF THE INVENTION

The invention generally relates to testing apparatuses and methods of testing test specimens using testing apparatuses.

Bistable specimens refer to materials or structures that possess two stable equilibrium configurations. These configurations can be achieved through specific geometric or material properties, resulting in structures capable of snapping between two distinct states. Understanding the behavior of bistable specimens is crucial for various applications, including the development of innovative designs for mechanical and aerospace systems.

Traditional testing methods, such as the basic 4-point bend setup shown in FIG. 1, face challenges when dealing with bistable specimens, particularly those with rigid shell designs that are well-known for their snap instabilities. The bistability of these specimens often prevents proper unloading during testing due to loss of contact with the test specimen, leading to incomplete information and/or inaccuracies in assessing their snap instabilities and energy dissipation capacities. The inability to account for the unique characteristics of bistable designs hinders the comprehensive understanding of their intricate mechanical behavior.

For example, as illustrated in FIG. 1, initially, the bistable tape spring is in its pre-snapped state and is subjected to loading of a test load until it experiences snap-through, transforming into its second stable state. In this altered configuration of the second stable state, the test setup is configured to unload. However, because the tape spring achieves equilibrium in the second stable state, there is no continuous contact between the test fixtures and the test specimen as the test load is removed, and the test loading setup reverts to its initial state while the test specimen remains in its second configuration. Consequently, this standard setup may not capture various unloading mechanical behavior of the tape spring needed for quantifying the energy dissipated by the ridge shell during its snapping behavior during unloading from the second stable state back to the first stable state.

Therefore, it would be desirable to have a testing apparatus that could obtain mechanical behavior information of a bistable and/or other multistable specimen during both loading and unloading.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, testing apparatuses and methods of testing test specimens using such a testing apparatus.

According to a nonlimiting aspect, a testing apparatus includes a first specimen holder, a second specimen holder, and a gap therebetween for a test specimen. The first specimen holder includes a first slot. The first specimen holder may include a first coupler for coupling to a test specimen in the gap. The second specimen holder may include a second coupler for coupling the second specimen holder to a second end of a test specimen in the gap. A first support fixture may pivotably support the first specimen holder. A second support fixture may pivotably support the second specimen holder. A first loading fixture is movably disposed within the first slot. The first loading fixture is configured to urge the first specimen holder to pivot in a first direction about the first support and to urge the first specimen holder to pivot in a second direction opposite the first direction about the first support. The testing apparatus may be used, among other things, for testing flexural characteristics of beams, including for example, various bistable and/or multistable members.

According to another nonlimiting aspect, a method of testing a test specimen to obtain flexural data from the test specimen using the testing apparatus described above is provided. The method may include operatively mounting the test specimen to the first specimen holder and the second specimen holder in a first position. Loading flexural information may be captured from the test specimen while loading the test specimen by urging the first specimen holder in the first direction from the first position to a second position with the first loading fixture. Unloading flexural information may be captured from the test specimen while unloading the test specimen by urging the first specimen holder in a second direction from the second position toward the first position with the first loading fixture.

Technical aspects of testing apparatuses and methods as described above preferably include the ability to obtain mechanical behavior information of a bistable and/or other multistable specimen during both loading and unloading, optionally with the ability for the unloading process to be implemented without dismounting or otherwise repositioning a test specimen or other sensors or components of the testing apparatus after the loading process while still obtaining suitable flexural information.

These and other aspects, arrangements, features, and/or technical effects will become apparent upon detailed inspection of the figures and the following description.

### BRIEF DESCRIPTION OF THE DRAWINGS

FIG. 1 a schematic representation of a conventional ASTM D6272 4-point bending setup and testing movements according to the prior art.

FIG. 2 is an isometric view of a testing apparatus in a testing setup according to certain nonlimiting aspects of the present invention with a multistable beam specimen mounted therein for flexion testing.

FIG. 3 is an exploded isometric view of the testing apparatus of FIG. 2.

FIG. 4 is an elevation view of the testing apparatus and testing setup of FIG. 2 illustrating a step-by-step a progression through a cycle of a nonlimiting example testing process for which the testing apparatus may be used.

FIG. 5 is a top perspective view of a bistable specimen according to some aspects of the invention.

FIG. 6 illustrates a method of using the testing apparatus according to some aspects of the invention.

### DETAILED DESCRIPTION OF THE INVENTION

The intended purpose of the following detailed description of the invention and the phraseology and terminology employed therein is to describe one or more nonlimiting embodiments of the invention, and to describe certain but not all aspects of what is depicted in the drawings, including the embodiment(s) to which the drawings relate. The following detailed description also describes certain investigations relating to the embodiment(s) and identifies certain but not all alternatives of the embodiment(s). As nonlimiting examples, the invention encompasses additional or alternative embodiments in which one or more features or aspects shown and/or described as part of a particular embodiment could be eliminated and encompasses additional or alternative embodiments that combine two or more features or aspects shown and/or described as part of different embodiments. Therefore, the appended claims, and not the detailed description, are intended to particularly point out subject matter regarded to be aspects of the invention, including certain but not necessarily all of the aspects and alternatives described in the detailed description.

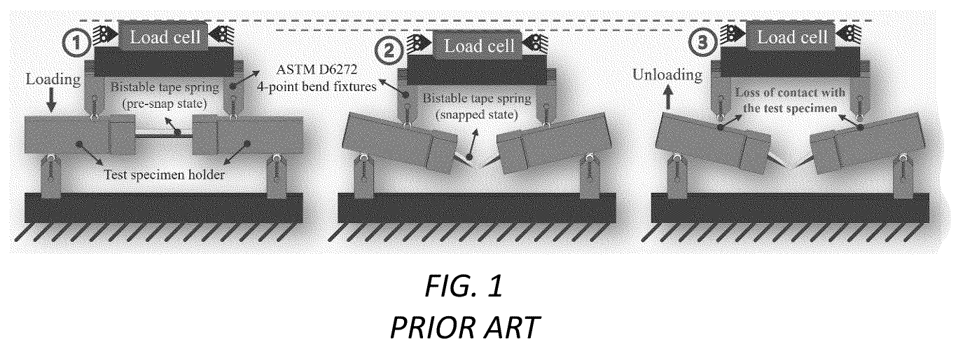

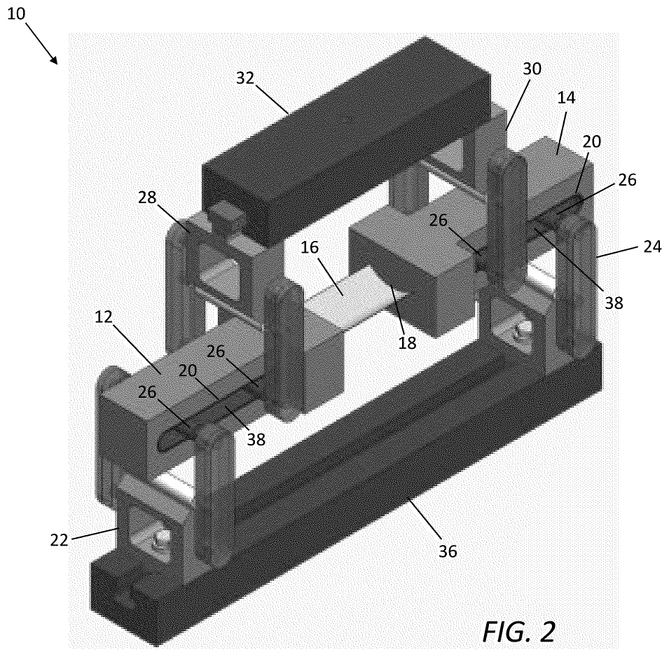

FIGS. 2 through 6 represent nonlimiting embodiments and aspects of a testing apparatus 10 configured as a testing jig adapted to obtain flexural characteristics of various types of beams. The testing apparatus 10 further provides a testing setup having a modified (e.g., relative to the conventional configuration of FIG. 1) four-point bend configuration that can obtain more robust flexural information regarding the bistability of rigid shell designs. The testing apparatus 10 can be readily configured to capture both loading and unloading load-displacement curves of bistable specimens without having to re-orient the test specimens or the testing apparatus 10 between the loading phase and the unloading phase of the testing. This may thereby provide a more accurate assessment of the energy dissipation capacities of the test specimens in a significantly simpler manner than previously possible.

Although the invention will be described hereinafter in reference to conducting various flexural tests to the bistable tape spring shown in the drawings, it will be appreciated that the teachings of the invention are more generally applicable to a variety of test specimens for which flexural test information may be desired, such as other types of beams and/or multistable flexural members, by way of nonlimiting example.

To facilitate the description provided below of the embodiment(s) represented in the drawings, relative terms, including but not limited to, “proximal,” “distal,” “anterior,” “posterior,” “vertical,” “horizontal,” “lateral,” “front,” “rear,” “side,” “forward,” “rearward,” “top,” “bottom,” “upper,” “lower,” “above,” “below,” “right,” “left,” etc., may be used in reference to the orientation of the testing apparatus 10 during its use and/or as represented in the drawings. All such relative terms are useful to describe the illustrated embodiment(s) but should not be otherwise interpreted as limiting the scope of the invention.

As used herein the terms “a” and “an” to introduce a feature are used as open-ended, inclusive terms to refer to at least one, or one or more of the features, and are not limited to only one such feature unless otherwise expressly indicated. Similarly, use of the term “the” in reference to a feature previously introduced using the term “a” or “an” does not thereafter limit the feature to only a single instance of such feature unless otherwise expressly indicated.

As will be discussed below, the testing apparatus 10 incorporates one or more slots 20 in one or more specimen holders 12 and 14 to establish uninterrupted contact between test loading fixtures 28 and 30 and a test specimen through a cycle of both loading and unloading the test specimen. In a nonlimiting example of testing a bistable tape spring, initially, the bistable tape spring, in its pre-snapped state, undergoes flexural loading in a first direction via engagement members, represented in the drawings as rollers 26, within the slots 20 of the test specimen holders 12 and 14 until the test specimen experiences snap-through, transitioning into its second stable state. The slots 20 may be internally layered with polytetrafluoroethylene (PTFE), such as Teflon®, to align with ASTM D6272 4-point bending standards. Due to the consistent engagement of the engagement member with the test specimen holder 12/14, the setup also facilitates unloading. As the loading fixture 28/30 returns to its starting point, the test specimen also reverts to its initial configuration. Because of this, a load cell operatively coupled to the loading fixture(s) 28/30 can accurately capture the unloading load-displacement curve as well as the loading load-displacement curve, thereby enabling precise measurement of the energy dissipated by the bistable tape spring during its snap in both directions between its two stable configurations. In some configurations, the test setup of the testing apparatus 10 may be reversible, allowing for loading and unloading in two vertically opposite directions from an initial setup state. For example, the testing apparatus 10 may be configured to test flexural characteristics both downwardly from an axially aligned neutral position (e.g., horizontal) and upwardly from the axially aligned neutral position. Additionally, the testing process may be cyclically repeatable by consistently returning the testing apparatus to its initial setup state while maintaining continuous contact with the testing fixture(s) 28/30.

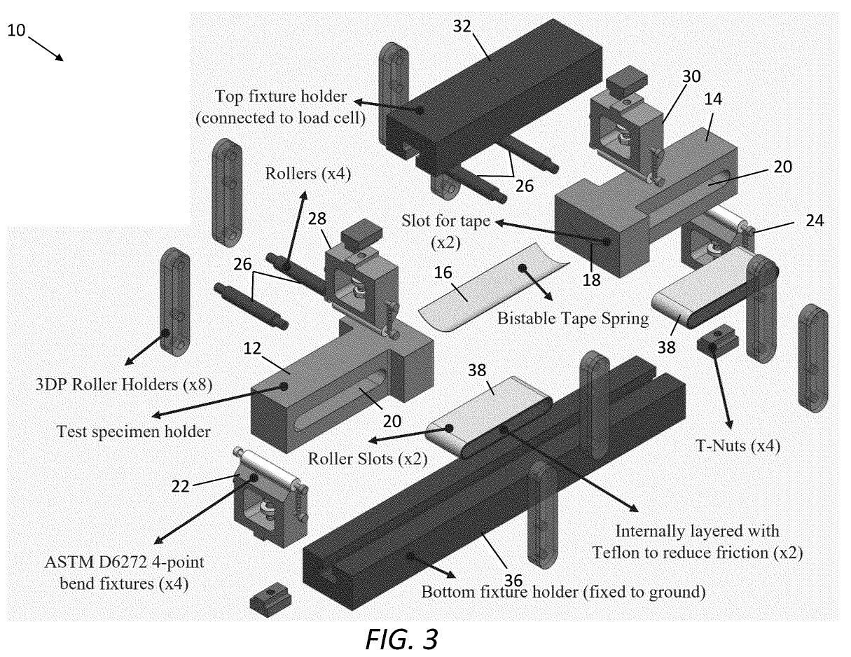

Turning now to the embodiment shown in FIGS. 2 and 3, the testing apparatus 10 is represented as being used for testing flexural characteristics of beams or other types of test specimens for which flexural tests may be desired. In some particular nonlimiting usage scenarios, the testing apparatus 10 can be used to test beam structures with bistable or other multistable configurations for various flexural characteristics. In some nonlimiting configurations, for example, the testing apparatus 10 can provide a four-point bend testing setup that addresses the inherent challenges associated with bistable specimens, particularly those featuring rigid shell designs prone to snap instabilities. Unlike conventional the four-point testing apparatus, the testing apparatus of the present invention can facilitate the capture of flexural characteristics during both loading and unloading, such as both loading and unloading load-displacement curves of bistable specimens, without reconfiguring the testing setup, thereby providing a more comprehensive assessment of their energy dissipation capacities.

The testing apparatus 10 is represented in the drawings as including first and second specimen holders 12 and 14 that are spaced apart from each other and configured to couple to opposite ends of a test specimen 16 at least partially spanning a gap between opposing inner faces of the specimen holders 12 and 14. Each specimen holder 12 and 14 may have a generally elongate beam shape that, in a neutral, unloaded position shown in FIG. 2, has a lengthwise axis that is horizontally oriented with an inner end carrying a coupler 18 for coupling to one of the opposite ends of the test specimen 16 and an outer end opposite the inner end. The inner ends may form the inner faces and face each other. The couplers 18 may be disposed on the inner faces of the inner ends directly opposite and facing each other to facilitate coupling the opposite ends of the test specimen 16 to the two couplers 18.

A slot 20 is defined in each specimen holder 12 and 14. The slots 20 may be disposed along the lengthwise axes of the specimen holders 12 and 14. Each slot 20 may extend partly along the length of the specimen holder 12 or 14 such that the opposite axial ends of the slot 20 are spaced from the respective opposite ends of the specimen holder 12/14, thereby having a fixed length that is shorter than the length of the specimen holder 12/14. The slot 20 may extend all the way through the specimen holder 12/14 in a width direction (perpendicular to the lengthwise axis) such that a pin or rod can extend all the way through the width of the specimen holder 12/14. In other embodiments, the slot 20 may be located in other orientations and/or locations along the specimen holders 12 and 14 and/or defined by other components of the specimen holder 12/14 and/or may extend only part way through the specimen holder 12/14. The incorporation of slots 20 on the specimen holders 12 and 14 can ensure continuous contact between the holders 12 and 14 and the bistable specimen 16.

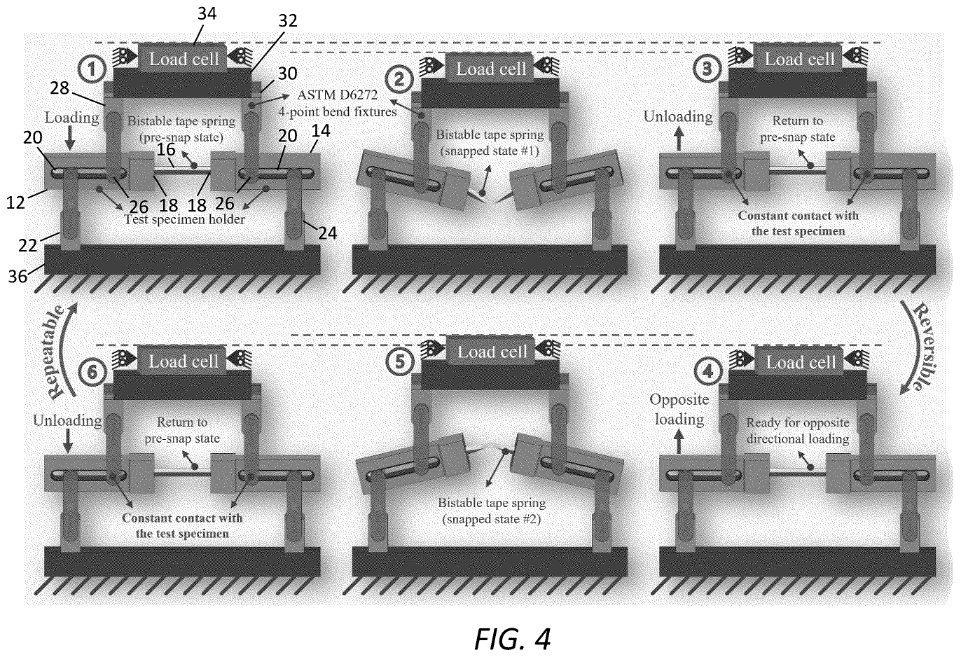

A first support fixture 22 is shown as pivotably supporting the first specimen holder 12, and a second support fixture 24 is shown as pivotably supporting the second specimen holder 14. In this way, each specimen holder 12 and 14 can be configured to pivot up and down about the respective the first or second support fixtures 22 and 24 to be able to bend/flex the test specimen 16 coupled therebetween in a controlled manner. Each support fixture 22 and 24 includes an engagement member, represented as a roller 26 that extends through the respective slot 20 such that the respective specimen holder 12/14 is supported by the roller 26 within the slot 20. The roller 26 may slide and/or roll axially along at least a partial length of the respective slot 20 such that the respective support fixture 22/24 can travel laterally (left/right as viewed in FIG. 4) along the axis of the slot 20. Typically, although not necessarily, this lateral travel of the support fixtures 22 and 24 within its respective slot 20 will be approximately perpendicular to the force vectors and/or direction of travel of the loading fixtures 28 and 30, in particular when the specimen holders 12 and 14 are in the neutral, unloaded configuration shown in FIG. 2. This may minimize or eliminate the influence of other forces unrelated to the pure flexure of the test specimen 16 from getting into test data obtained therefrom. However, the support fixtures 22 and 24 need not be disposed in and/or be able to slide along the slots 20. For example, in other embodiments, the support fixtures 22 and 24 may be pivotably coupled to the respective specimen holders 12 and 14 in other manners capable of allowing the specimen holders 12 and 14 to pivot up and down to flex/bend the test specimen 16 held therebetween.

A first of the loading fixtures 28 is movably disposed within the slot 20 of the first specimen holder 12 and is configured to urge the first specimen holder 12 to pivot in a first direction (e.g., downwardly as seen in the drawings) about the first support fixture 22. The first loading fixture 28 is also configured to urge the first specimen holder 12 to urge the first specimen holder 12 to pivot in a second direction opposite the first direction (e.g., upwardly as seen in the drawings) about the first support fixture 22. In similar manner, a second of the loading fixtures 30 may be movably disposed within the slot 20 of the second specimen holder 14 and configured to urge the second specimen holder 14 to pivot in the first direction and in the second direction about the second support fixture 24. The first and second loading fixtures 28 and 30 may be substantially similar to the first and second support fixtures 22 and 24, for example, including a roller (engagement member) 26 that extends through its respective slot 20. In one nonlimiting example, the support fixtures 22 and 24 and the loading fixtures 28 and 30 are all ASTM D6272 four-point bend fixtures; however, other types and/or configurations of support and/or loading fixtures may be used.

In the example testing setup shown in the drawings, the specimen holders 12 and 14 in the neutral, unloaded position are disposed axially aligned with each other on opposite sides of a vertical setup centerline along their longitudinal axes with their inner faces facing each other and spaced apart, forming the gap therebetween for the test specimen 16. Typically, although not necessarily, such a setup will be arranged with the specimen holders 12 and 14 also being disposed horizontally for the sake of maintaining symmetry to various gravitational forces on the test specimen 16 during a test procedure. In this setup, the specimen holders 12 and 14 pivot up and down transverse to the horizontal neutral axis of the specimen holders 12 and 14 and/or an axis defined through the two opposing couplers 18. The slots 20 may be parallel and/or coaxial with the horizontal neutral axis of the specimen holders 12 and 14 and/or an axis defined through the two opposing couplers 18. The loading fixtures 28 and 30 for the respective specimen holders 12 and 14 are spaced interiorly (toward the vertical setup centerline) apart from the respective support fixtures 22 and 24. In this configuration, when the loading fixtures 28 and 30 apply a force downwardly, the inner facing ends of the specimen holders 12 and 14 carrying the opposing couplers 18 will be rotated downwardly, pivoting about the respective support fixtures 22 and 24. Likewise, when the loading fixtures 28 and 30 apply a force upwardly, the inner facing ends of the specimen holders 12 and 14 will also be rotated upwardly, pivoting about the respective support fixtures 22 and 24. Because the loading fixtures 28 and 30 can apply loads in at least two opposite directions (e.g., up and down) to the specimen holders 12 and 14, the testing apparatus 10 may be configured to apply loads repeatably. In addition, in some configurations, the testing apparatus 10 may be configured to apply flexural loading in reversibly in opposite directions (e.g., both up and down), such as in a first downwardly direction below the neutral axis and a second upwardly direction above the neutral axis, as illustrated, for example, in FIG. 4. In this way, the testing apparatus 10 may provide significant additional testing capabilities relative to conventional apparatuses as exemplified in FIG. 1.

The roller 26 may be sized to minimize any gaps between the roller 26 and the upper and lower walls of the slot 20. For example, the roller 26 may have a diameter that is substantially the same as or only slightly less than the height of the slot 20 such that both the top of the roller 26 and the bottom of the roller 26 always engage the respective opposite top and bottom walls of the slot 20 simultaneously. This can ensure that there is always or nearly always positive engagement between the roller 26 and its respective specimen holder 12 or 14 when the direction of urging (e.g., up or down) is changed, thereby eliminating or reducing any lag between movement of the specimen holder 12/14 and the loading fixture 22/24. The slot 20 may have a substantially uniform height between its upper and lower walls along its length. If the roller 26 is or includes a roller, the roller may roll and/or slide along at least a portion of the length of the slot. In other embodiments, the loading fixtures 28 and 30 may include other types of engagement members that are movably disposed in the respective slots 20 and suitable for urging the respective specimen holder 12 or 14 in the first and second directions.

The first loading fixture 28 and the second loading fixture 30 may be operatively coupled to each other to simultaneously urge the first and second specimen holders 12 and 14 in the first or second direction simultaneously and/or synchronously. For example, both the first and second loading fixture 28 may be attached to a rigid top fixture holder 32 that is in turn connected to a one or more load cells 34. In this way, pressure and/or tension applied by the load cell(s) 34 simultaneously and synchronously urges both loading fixtures 28 and 30, and thus their respective specimen holders 12 and 14, in the same direction (e.g., up or down) at the same time. The top fixture holder 32 may be a substantially rigid body, such as a relatively stiff beam, oriented horizontally and above the inner ends of the specimen holders 12 and 14. The loading fixtures 28 and 30 may be mounted on opposite ends of the top fixture holder 32 with any suitable mounting hardware, such as T-nuts that can mount into a corresponding slot along the bottom side of the fixture holder. The load cell(s) 34 may be any suitable mechanism for applying loads and/or recording loading data for conducting the flexural loading tests on the test specimen 16. The load cell 34 may be configured to apply the loads in both the first and second direction. In other embodiments, the first and second loading fixtures 28 and 30 may operate independently and/or not simultaneously and/or not synchronously. For example, each loading fixture 28 and 30 may be coupled to a different load cell that apply loads independently of each other.

The support fixtures 22 and 24 may be operatively coupled to each other so that they are maintained in a fixed position and/or orientation relative to each other during tests procedures. In this example, both support fixtures 22 and 24 are attached to a rigid bottom fixture holder 36, which thereby supports both support fixtures 22 and 24 and both specimen holders 12 and 14. The bottom fixture holder 36 may be a substantially rigid body, such as a relatively stiff beam, oriented horizontally and below the outer ends of the specimen holders 12 and 14. The support fixtures 22 and 24 may be mounted on opposite ends of the bottom fixture holder 36 with any suitable mounting hardware, such as T-nuts that can mount into a corresponding slot 20 along the bottom side of the fixture holder 36.

A low-friction lining 38 may be disposed on the inner surface(s) of the slots 20 to reduce the effects of friction between the loading fixtures 28 and 30 and/or the support fixtures 22 and 24 and the respective specimen holders 12 and 14 during flexural tests. The low-friction lining 38 may include a liner and/or a chemical coating along the walls of the slot 20. For example, the low-friction lining 38 may include a layer of polytetrafluoroethylene (PTFE) along the walls of the slot 20 that engage the roller(s) 26. The low-friction lining 38 may include a liner sleeve made of low-friction and/or high-strength material, such as high strength metal alloys, ceramics, and/or composite materials that define the exposed walls of the slots 20. Such a liner sleeve may in turn also be coated with a layer of PTFE. Other low-friction linings could be used.

The couplers 18 may take any form suitable for coupling to a test specimen. For example, the couplers 18 may include clamps, receivers, locking mechanism, and/or other components for releasably and/or fixedly connecting the test specimen 16 to the respective specimen holder 12 or 14. In this nonlimiting example, the couplers 18 include complementary arcuate slots extending into the opposing inner faces of the specimen holders 12 and 14 and configured to receive the respective curved ends of a bistable spring formed by a beam having a similarly arcuate cross-section.

In the embodiment represented in the drawings, the left and right sides of the testing apparatus 10 are substantially symmetrical about a vertical centerline between the specimen holders 12 and 14, and the specimen holders 12 and 14 are substantially identical and/or are mirror images of each; however, such left/right symmetry is not necessary. In other embodiments, the specimen holders 12 and 14 may have different configurations from each other and/or the left and right sides of the testing apparatus 10 may not be substantially symmetrical about the centerline. For example, in some embodiments, only one of the specimen holders 12 or 14 may include the slot 20 while the other specimen holder 12 or 14 has a different engagement mechanism for its respective loading fixture 28/30 and/or support fixture 22/24, different location for its slot 20, etc.

The efficacy of a testing apparatus as described above was elucidated through an exemplary sequential testing process outlined in FIG. 4, which illustrates a test cycle implemented using the testing apparatus 10 on a test specimen 16. This testing process illustrates both reversibility and repeatability features of the testing apparatus 10 in one possible testing set up. This sequential testing process demonstrates a sequence of loading (1), snap-through to a first state (2), unloading to return to the initial state (3), reversibility of the setup in vertically opposite direction (4), (5), and (6), and cyclic repeatability, highlighting the effectiveness of the testing apparatus 10 for capturing bistable tape spring behavior. In this example, the test specimen 16 is in the form of a beam, and in particular of a bistable hierarchical tape spring. Other types and/or configurations of test specimens could be used. More specifically, initially, the testing apparatus 10 is in its neutral, unloaded position at (1) with the bistable tape spring in its pre-snapped state. The test specimen then undergoes downward loading via rollers within the slots 20 until it experiences snap-through, transitioning into its second stable state at (2). Due to the consistent engagement of the rollers with the test specimen, the setup also facilitates controlled unloading. As the loading fixtures 28 and 30 return upwardly to their starting points in the neutral, unloaded position, the test specimen may also revert to its initial configuration back to its pre-snapped state at (3). Because there is continuous engagement between the specimen holders 12 and 14 and their respective loading fixtures 28 and 30, the load cell 34 may accurately capture the unloading load-displacement curve, enabling precise measurement of the energy dissipated by the bistable tape spring during its snap back to the pre-snapped state.

Moreover, the test setup represented in the drawings is reversible, allowing for loading and unloading in two vertically opposite directions. Thus, for example, at (4) the testing apparatus 10 is again in its neutral, unloaded position, and the test specimen is at its pre-snapped state and ready for loading in the opposite direction, namely upwardly. From here, the test specimen undergoes upward loading via rollers within the slots 20 until it experiences snap-through, transitioning into its third stable state at (5). Due to the consistent engagement of the rollers with the test specimen, the setup also facilitates controlled unloading. As the loading fixtures 28 and 30 return downwardly to their starting points in the neutral, unloaded position, the test specimen may also revert to its initial configuration back to its pre-snapped state at (6). As with the downward test direction, because there is continuous engagement between the specimen holders 12 and 14 and their respective loading fixtures 28 and 30, the load cell 34 may accurately capture the unloading load-displacement curve, enabling precise measurement of the energy dissipated by the bistable tape spring during its snap back to the pre-snapped state.

Additionally, the testing apparatus 10 allows the test process to be cyclically repeatable by consistently returning to its initial setup state (the neutral, unloaded position) while maintaining continuous contact. In addition, the test process can be repeated selectively for only of the directions (e.g., positions 1-3 or 4-6) and need not complete the entire cycle of both up and down flexure.

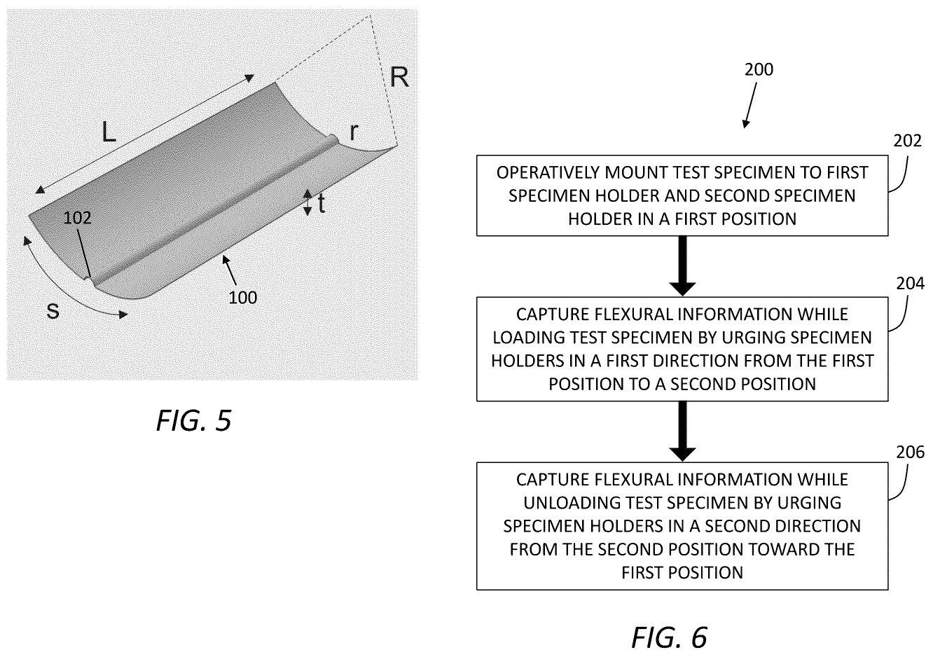

Provided as a non-limiting example, a system as described above was experimentally utilized for testing hierarchical tape springs. The hierarchical tape springs were essentially generic tape springs with one or more longitudinal ridges along their middle. FIG. 5 diagrammatically illustrates one nonlimiting example of such a hierarchical tape spring 100, which includes an elongate body forming a thin strip having an arcuate lateral cross-sectional shape with a larger radius extending along its length and a small longitudinal ridge 102 with a much smaller radius formed along the strip spaced between opposite lateral edges of the strip. To experimentally quantify and validate the energy dissipation capacities of these bistable hierarchical tape springs, mechanical load-displacement curves were obtained in both senses of loading. The testing apparatus 10 was used to capture these curves accurately, as the setup facilitated a continuous loading and unloading process, allowing for a comprehensive assessment of the energy dissipation capabilities.

For the experiments, each hierarchical tape spring design underwent multiple cycles of loading and unloading in both senses of downward bending and upward bending, for example, as represented in FIG. 4. The same design was tested three times with new sample preparations for each iteration, employing a vacuum forming method for fabricating the tape designs. The experimental results obtained from these specimen tests captured both loading and unloading load-displacement curves of these bistable/multistable specimens in both the downward and upward bending directions, providing a comprehensive assessment of their energy dissipation capacities. Multiple tape spring designs were considered and finite element analysis simulations were conducted for each hierarchical tape spring design. The experimental results obtained from the specialized testing setup matched well with the computational results, which helped validate the accuracy of both approaches. The rigorous testing process ensured the reliability and repeatability of the findings, providing a robust understanding of the mechanical behavior and energy dissipation capacities of the hierarchical tape springs.

These investigations showed that a testing setup utilizing the testing apparatus 10 may not only solve challenges associated with testing thin curved shells but may also be used for testing most bistable specimens and other beam-type structures. The applications of this system may extend to diverse scenarios, such as evaluating the deploying capacities of satellites, characterizing shape memory alloys, and assessing the structural resilience of various materials and structures. The continuous contact mechanism offered by the slots 20 opens avenues for studying the dynamic behaviors of various structures subjected to snap-through functionality, as well as other types of flexural characteristics.

The testing apparatus 10 may be used in many various ways and testing methods. Such methods may include disposing and/or mounting a specimen between the first specimen holder 12 and the second specimen holder 14. Next, the specimen may be moved in a first direction to a first flexural position while maintaining contact between the loading fixtures 28 and 30 and each of the first specimen holder 12 and the second specimen holder 14, during which the load cell 34 may capture a loading load-displacement curve of the specimen. Then, the specimen may then be moved in a second direction to a second flexural position while continuing to maintain contact between the loading fixtures 28 and 30 and each of the first specimen holder 12 and the second specimen holder 14, during which the load cell 34 may then capture an unloading load-displacement curve of the specimen.

FIG. 6 illustrates one possible method 200 of using the testing apparatus 10 for testing a beam specimen such as the hierarchical tape spring 100 for various flexural characteristics, such as load-displacement curves. At 202, a test specimen 16 is operatively mounted in the testing apparatus 10. For example, the test specimen 16 may be mounted to and between the first specimen holder 12 and the second specimen holder 14 in a first stable (unloaded) configuration. This may include coupling one end of the specimen 16 to the coupler 18 on the first specimen holder 12 and coupling the other end of the specimen 16 to the coupler 18 on the second specimen holder 14 when in the neutral, unloaded position shown in in the upper left position of FIG. 4. After being operatively mounted, at 204 the loading fixtures 28 and 30 can load the specimen holders 12 and 14 by moving or otherwise urging them a first direction (e.g., downwardly) to pivot the specimen holders 12 and 14 downwardly about their respective support fixtures 22 and 24. As this occurs, the loading fixtures 28 and 30 can also slide and/or roll along the slots 22. As the specimen holders 12 and 14 pivot downwardly, the test specimen 16 is subsequently flexed downwardly, and various flexural information (e.g., load-displacement data) can be obtained during this downward flexing by any suitable arrangement of sensors via the engagement between the loading fixtures 28 and 30 and their respective slots 20. If the test specimen 16 is a bistable beam, then the specimen can be flexed until it reaches its second stable configuration. Thereafter, at 206, the loading fixtures 28 and 30 can unload the specimen holders 12 and 14 by moving or otherwise urging them a second direction (e.g., upwardly) to pivot the specimen holders 12 and 14 back upwardly about their respective support fixtures 22 and 24. This unloading process may be implemented in some setups without having to dismount or otherwise reposition the test specimen or other sensors or components of the testing apparatus 10 after the loading process. As this occurs, the loading fixtures 28 and 30 can again slide and/or roll along the slots 22. As the specimen holders 12 and 14 pivot back upwardly, the test specimen 16 is subsequently flexed upwardly, and various flexural information (e.g., load-displacement data) can be obtained during the upward flexing by any suitable arrangement of sensors via the engagement between the loading fixtures 28 and 30 and their respective slots 20. If the test specimen 16 is a bistable beam, then the specimen can be flexed from its second stable configuration back to its first stable configuration in the neutral, unloaded position. In a similar manner, the method could reverse the testing direction (e.g., upwardly) to obtain flexural information while the test specimen is flexed upwardly and then back to the neutral, unloaded position. Advantageously, all these steps can be performed in both directions, and the corresponding flexural data obtained, without having to reposition the test specimen 16 and/or reposition any of the components of the testing apparatus 10 after having operatively mounted the test specimen. Thus, the testing apparatus 10 makes it much easier and/or faster to obtain flexural data from the entire range of flexure of the test specimen. Other suitable setups and methods to use the testing apparatus 10 may also be implemented.

The testing apparatus 10 could be useful for industries involved in mechanical testing, materials characterization, aerospace engineering, deploying structures, and companies working on shape memory materials, etc.

As previously noted above, though the foregoing detailed description describes certain aspects of one or more particular embodiments of the invention, alternatives could be adopted by one skilled in the art. For example, the testing apparatus 10 and its components could differ in appearance and construction from the embodiments described herein and shown in the drawings, functions of certain components of the testing apparatus 10 could be performed by components of different construction but capable of a similar (though not necessarily equivalent) function, and various materials could be used in the fabrication of the testing apparatus 10 and/or its components. As such, and again as was previously noted, it should be understood that the invention is not necessarily limited to any particular embodiment described herein or illustrated in the drawings.

1. A testing apparatus for testing flexural characteristics of beams, the testing apparatus comprising:
a first specimen holder spaced apart from a second specimen holder and defining a gap therebetween for a test specimen, wherein the first specimen holder comprises a first slot and a first coupler for coupling the first specimen holder to a first end of a test specimen in the gap, and wherein the second specimen holder comprises a second coupler for coupling the second specimen holder to a second end of a test specimen in the gap;
a first support fixture pivotably supporting the first specimen holder, and a second support fixture pivotably supporting the second specimen holder; and
a first loading fixture movably disposed within the first slot and configured to urge the first specimen holder to pivot in a first direction about the first support and to urge the first specimen holder to pivot in a second direction opposite the first direction about the first support.

2. The testing apparatus of claim 1, wherein the first loading fixture comprises a first roller that travels along the first slot as the first loading fixture pivots in each of the first direction and the second direction.

3. The testing apparatus of claim 2, wherein the first roller slides and/or rolls along opposite inner surfaces of the first slot as the first loading fixture pivots in each of the first direction and the second direction, respectively.

4. The testing apparatus of claim 3, further comprising a low-friction lining disposed on an in surface of the first slot that reduces friction between the first loading fixture and the first slot.

5. The testing apparatus of claim 4, wherein the low-friction lining comprises a layer of polytetrafluoroethylene that engages the roller.

6. The testing apparatus of claim 1, wherein the first support fixture is movably disposed within the first slot and spaced apart from the first loading fixture.

7. The testing apparatus of claim 6, wherein the first support fixture comprises a second roller that travels along the first slot as the first loading fixture pivots in each of the first direction and the second direction.

8. The testing apparatus of claim 7, wherein the second specimen holder comprises a second slot, and further comprising a second loading fixture movably disposed within the second slot and configured to urge the second specimen holder to pivot in the first direction about the second support and to urge the second specimen holder to pivot in the second direction about the second support simultaneously with the first specimen holder.

9. The testing apparatus of claim 8, wherein the second loading fixture comprises a third roller that rolls and/or slides along opposite inner surfaces of the second slot as the second loading fixture pivots in each of the first direction and the second direction, respectively.

10. The testing apparatus of claim 8, wherein the second support fixture is movably disposed with the second slot and spaced apart from the second loading fixture.

11. The testing apparatus of claim 10, wherein the second support fixture comprises a fourth roller that travels along the second slot as the second loading fixture pivots in each of the first direction and the second direction.

12. The testing apparatus of claim 8, wherein the first direction and the second direction are transverse to an axis extending from the first coupler to the second coupler.

13. The testing apparatus of claim 12, wherein each of the first slot and the second slot is parallel with the axis.

14. The testing apparatus of claim 1, wherein the first coupler and the second coupler are configured to couple to opposite ends of a beam test specimen.

15. The testing apparatus of claim 1, wherein the first coupler and the second coupler are configured to couple to opposite ends of a test specimen comprising a bistable tape spring.

16. A method of testing a test specimen using the testing apparatus of claim 1 to obtain flexural data from the test specimen, the method comprising:
operatively mounting the test specimen to the first specimen holder and the second specimen holder in a first position;
capturing loading flexural information from the test specimen while loading the test specimen by urging the first specimen holder in the first direction from the first position to a second position with the first loading fixture; and
capturing unloading flexural information from the test specimen while unloading the test specimen by urging the first specimen holder in a second direction from the second position toward the first position with the first loading fixture.

17. The method of claim 16, wherein the first loading fixture maintains physical engagement with the slot throughout both the loading and the unloading.

18. The method of claim 17, wherein the first loading fixture slides and/or rolls along the slot during the loading and/or unloading.

19. The method of claim 16, wherein the first specimen holder and the second specimen holder pivot about the first support fixture and the second support fixture, respectively, during the loading and unloading.

20. The method of claim 19, wherein the first support fixture slides and/or rolls along its slot during the loading and/or unloading.
